(19) United States
(12) Patent Application Publication
(10) Pub. No.: US 2008/0134816 A1
(43) Pub. Date: Jun. 12, 2008

(54) Ball screw device having lubricating device

(75) Inventors: Yan Yu Chen, Taichung (TW); Wen Chia Wu, Taichung (TW)

Correspondence Address: CHARLES E. BAXLEY, ESQ., 90 JOHN STREET, THIRD FLOOR, NEW YORK, NY, 10038, US

(73) Assignee: Hiwin Technologies Corp.

(21) Appl. No.: 11/637,344

(22) Filed: Dec. 12, 2006

(51) Int. Cl. F16H 57/04; F16H 25/22

(52) U.S. Cl. 74/89.44

(57) ABSTRACT

A ball screw device includes a ball nut having an inner thread and a channel communicating with each other, a screw shaft threaded with the ball nut, a number of bearing members engaged in between the ball nut and the screw shaft and in the channel of the ball nut. A bearing housing is engaged onto the ball nut for forming a sealed annular gap between the bearing housing and the ball nut and for receiving a lubricating oil, and an oil forcing member includes an extension extended into the annular gap that is formed between the bearing housing and the ball nut for forcing or scrubbing or propelling the lubricating oil to flow into the channel in order to lubricate the bearing members.

### BACKGROUND OF THE INVENTION

1. Field of the Invention

The present invention relates to a ball screw device, and more particularly to a ball screw device having a lubricating device for effectively and easily lubricating the balls or the bearing members, and for facilitating the rotational movement of the ball nut and the screw shaft relative to each other in great rotational speeds.

2. Description of the Prior Art

Typical ball screw devices comprise a ball nut rotatably and/or moveably engaged onto a screw shaft, and normally arranged to allow the ball nut to be rotated and/or moved relative to the screw shaft in great rotational speeds. For allowing the ball nut to be smoothly rotated and moved relative to the screw shaft, a suitable bearing device or lubricating structure is further required to be provided and engaged between the ball nut and the screw shaft, for facilitating the rotational movement between the ball nut and the screw shaft.

For example, U.S. Pat. No. 5,809,838 to Miyaguchi et al. discloses one of the typical ball screw devices including an oil supplying structure having oil supplying holes formed in the ball nut and the outer ball race for supplying oil even when the typical ball screw device is in operation, and for eliminating the mounting and removal of the oil supplying pipes when supplying the oil. For lubricating the typical ball screw device, an annular gap will be formed between the ball nut and the outer ball race for filling and retaining the oil in the outer ball race.

However, the oil is simply filled into the annular gap of the outer ball race, but may not be forced into the endless ball train guiding passage of the ball nut that is provided for receiving the balls or bearing devices.

U.S. Pat. No. 6,732,600 to Greubel discloses another typical ball screw device including a ring chamber formed or arranged between an outer bearing part and an inner bearing part for receiving the lubricating oil.

However, similarly, the oil is simply filled into and retained in the ring chamber that is provided between the outer bearing part and the inner bearing part, but may not be forced into the moving path that is formed between a threaded spindle and a threaded nut and that is provided for receiving a roller bearing or balls.

The present invention has arisen to mitigate and/or obviate the afore-described disadvantages of the conventional ball screw devices for such as machine tools or the like.

### SUMMARY OF THE INVENTION

The primary objective of the present invention is to provide a ball screw device including a lubricating device or structure for effectively and easily lubricating the balls or the bearing members, and for facilitating the rotational movement of the ball nut and the screw shaft relative to each other in great rotational speeds.

In accordance with one aspect of the invention, there is provided a ball screw device comprising a ball nut including a bore formed therein, and including an inner thread formed therein, and including a channel formed the ball nut and communicating with the inner thread of the ball nut, and including an orifice formed in the ball nut and communicating with the channel of the ball nut, a screw shaft engaged into the bore of the ball nut and including an outer thread formed thereon for engaging with the inner thread of the ball nut and thus for allowing the ball nut to be rotated and moved relative to the screw shaft, and for forming a helical raceway between the ball nut and the screw shaft, a number of first bearing members engaged in the helical raceway that is formed between the ball nut and the screw shaft and in the channel of the ball nut for facilitating a movement between the ball nut and the screw shaft, a bearing housing rotatably engaged onto the ball nut for forming a sealed annular gap between the bearing housing and the ball nut, the bearing housing including a port formed therein and communicating with the annular gap that is formed between the bearing housing and the ball nut for filling a lubricating oil into the annular gap that is formed between the bearing housing and the ball nut and for lubricating the first bearing members, and a forcing device for forcing the lubricating oil to flow from the annular gap that is formed between the bearing housing and the ball nut to the channel of the ball nut.

The forcing device includes an oil forcing member engaged into the orifice of the ball nut and having an extension extended into the annular gap that is formed between the bearing housing and the ball nut for scrubbing and forcing the lubricating oil to flow from the annular gap that is formed between the bearing housing and the ball nut to the channel of the ball nut.

The oil forcing member includes a curved depression formed therein and communicating with the channel of the ball nut for receiving the first bearing members. The bearing housing includes two sealing rings engaged between the bearing housing and the ball nut for forming the annular gap between the bearing housing and the ball nut. The bearing housing includes two peripheral slots formed therein for receiving the sealing rings.

The oil forcing member includes at least one pathway formed therein and communicating with the annular gap that is formed between the bearing housing and the ball nut. The pathway is formed in either side portion of the oil forcing member. The side portion of the oil forcing member is preferably a curved side portion.

The ball nut includes an outer peripheral groove formed therein and communicating with the annular gap that is formed between the bearing housing and the ball nut for receiving the lubricating oil. The bearing housing includes a port formed therein and communicating with the annular gap that is formed between the bearing housing and the ball nut for filling the lubricating oil into the annular gap that is formed between the bearing housing and the ball nut.

The ball nut includes at least one cavity formed therein and communicating with the bore of the ball nut for receiving a ball deflecting member therein. The ball deflecting member includes a curved slot formed therein for communicating the channel and the inner thread of the ball nut with each other.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial perspective view of a ball screw device in accordance with the present invention, in which one quarter of the ball screw device has been cut off for showing an inner structure of the ball screw device;

FIG. 2 is a partial plan schematic view of the ball screw device, in which one quarter of the ball screw device has also been cut off for showing the inner structure of the ball screw device;

FIG. 3 is another partial perspective view of the ball screw device in which a screw shaft has been removed;

FIG. 4 is an enlarged partial perspective view of the ball screw device;

FIG. 5 is a further partial perspective view illustrating an outer bearing housing of the ball screw device; and

FIG. 6 is an enlarged perspective view illustrating an oil scrubbing or actuating or propelling member of the ball screw device.

### DETAILED DESCRIPTION OF THE PREFERRED EMBODIMENT

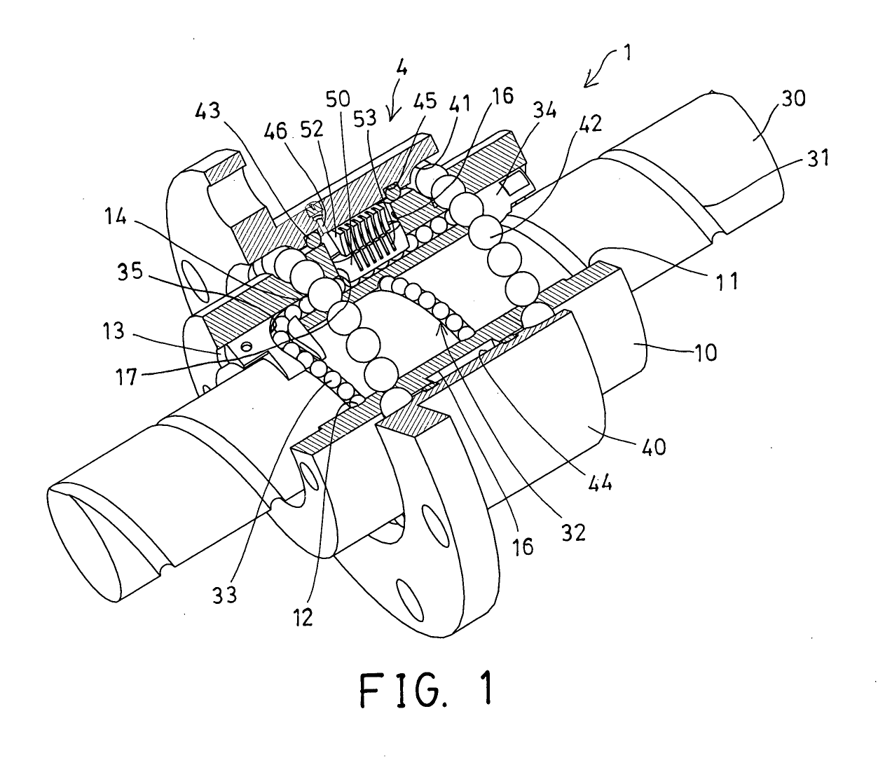

Referring to the drawings, and initially to FIGS. 1-3, a ball screw device 1 in accordance with the present invention comprises an outer ball nut 10 including a bore 11 formed therein for receiving a typical screw shaft 30 which includes an outer thread 31 formed on the outer peripheral portion thereof, and including an inner thread 12 formed in the ball nut 10 for threading with or for engaging with the outer thread 31 of the screw shaft 30 and thus for allowing the ball nut 10 to be smoothly moved along the screw shaft 30, or for allowing the screw shaft 30 to be smoothly rotated and moved relative to the ball nut 10. The threading engagement and/or the rotational engagement between the ball nut 10 and the screw shaft is typical and will not be described in further details.

A multiple turn, helical raceway 32 will be formed between the ball nut 10 and the screw shaft 30 by the outer thread 31 of the screw shaft 30 and the inner thread 12 of the ball nut 10 for rotatably and/or movably receiving one or more groups of balls or rollers or rolling or ball bearing members 33 therein which may facilitate the rotating movement of the ball nut 10 relative to the screw shaft 30 when the screw shaft 39 is forced to rotate relative to the ball nut 10 or when the ball nut 10 is forced to rotate relative to the screw shaft 30, in order to constitute the primary or basic structure of the ball screw device 1. The ball nut 10 includes one or more (such as two) cavities 13 formed therein and communicating with the bore 11 of the ball nut 10 for receiving ball guide or deflecting members 34 therein respectively.

The ball nut 10 further includes one or more channels 14 formed therein and communicating with the cavities 13 and/or the inner thread 12 of the ball nut 10 and the helical raceway 32 formed between the ball nut 10 and the screw shaft 30, it is preferable that the channels 14 are longitudinally formed in the ball nut 10 and passing through or intersecting with the cavities 13 of the ball nut 10 for receiving the ball bearing members 33 therein. For example, the deflecting members 34 each include a curved slot 35 formed therein for communicating the channels 14 and the inner thread 12 of the ball nut 10 with each other and for guiding the ball bearing members 33 to move into or out of the channels 14 of the ball nut 10 respectively and thus for forming the endless ball rolling passages. The provision of the deflecting members 34 and the engagement of the ball bearing members 33 between the ball nut 10 and the screw shaft 30 are also typical and will not be described in further details.

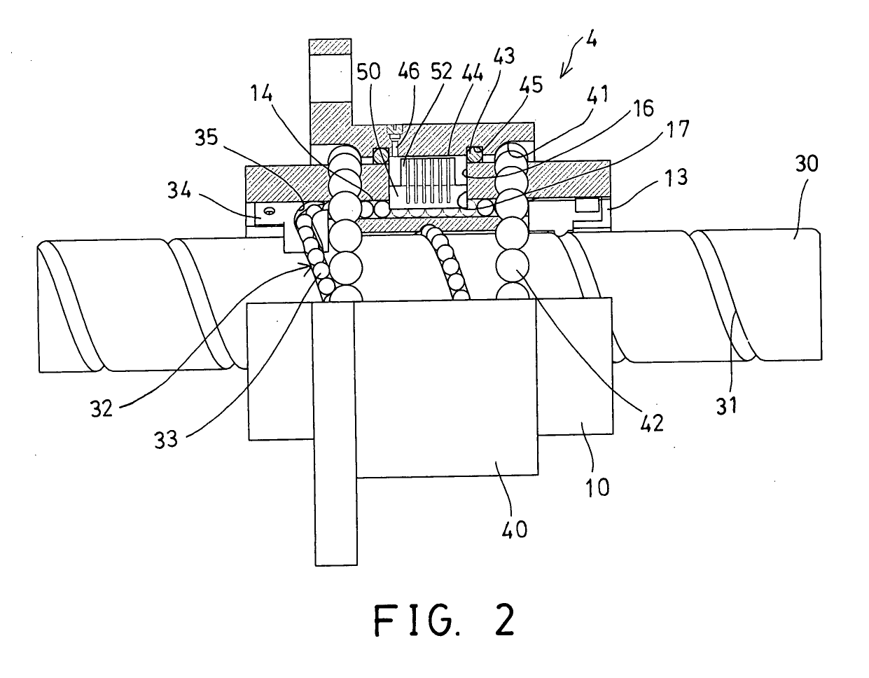

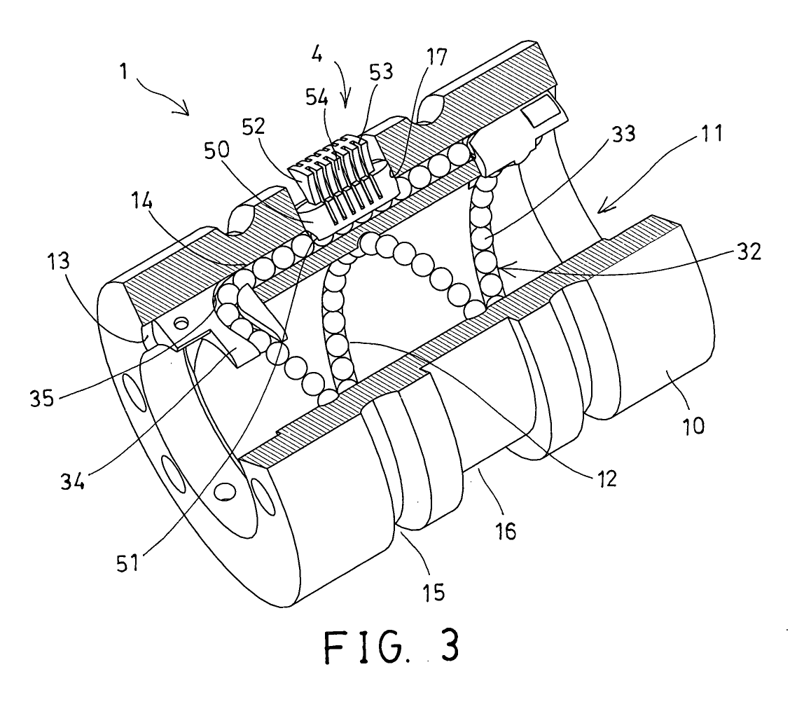

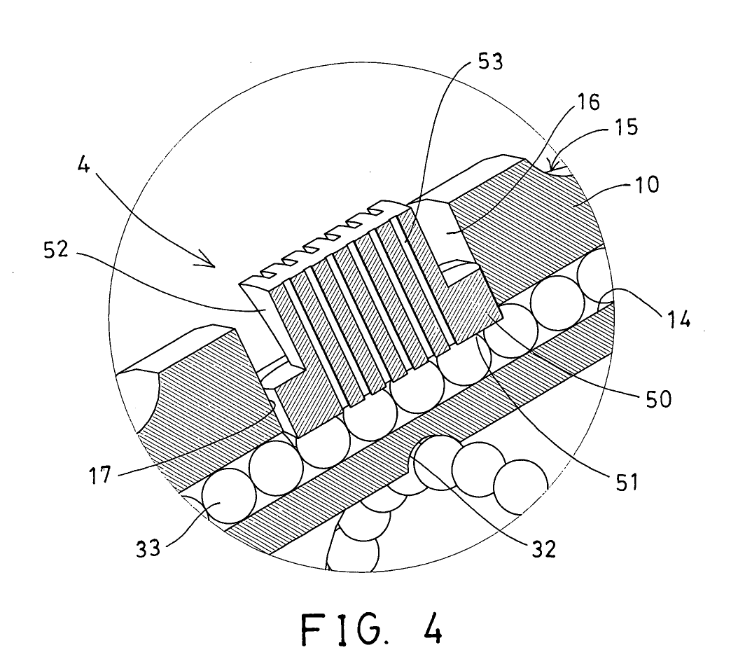

The ball screw device 1 in accordance with the present invention further includes a bearing or lubricating structure or device 4 attached onto the ball nut 10 and having an outer bearing housing 40 rotatably engaged onto the outer peripheral portion of the ball nut 10. It is preferable that the bearing housing 40 includes one or more (such as two) inner peripheral recesses 41 formed therein, and the ball nut 10 also includes one or more (such as two) outer peripheral recesses 15 formed therein (FIGS. 3, 4) and aligned with the inner peripheral recesses 41 of the bearing housing 40 for slidably or movably receiving the other ball bearing members 42 therein (FIGS. 1, 2) and thus for allowing the bearing housing 40 to be smoothly rotated relative to the ball nut 10.

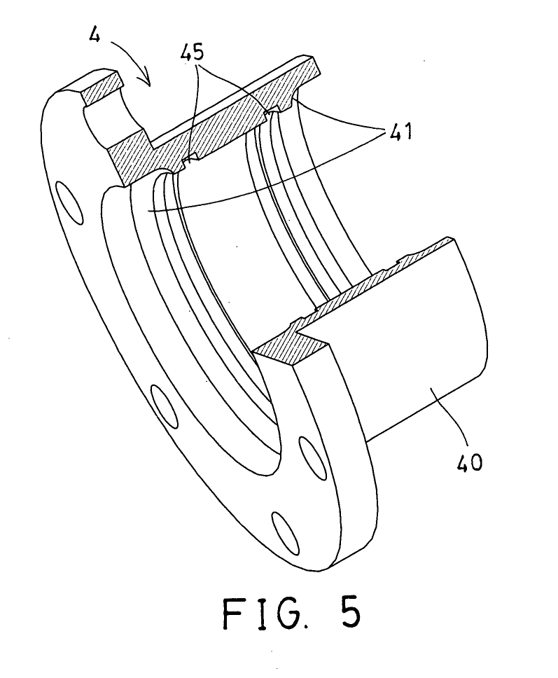

One or more (such as two) gaskets or sealing rings 43 are provided and engaged between the bearing housing 40 and the ball nut 10 for forming or defining an annular gap 44, particularly a sealed annular gap 44 between the bearing housing 40 and the ball nut 10 (FIGS. 1, 2) and for receiving the lubricating oil therein. It is preferable that the bearing housing 40 includes one or more (such as two) inner peripheral slots 45 formed therein (FIGS. 1, 2, 5) for receiving and anchoring and positioning the sealing rings 43 therein and for effectively retaining the lubricating oil within the annular gap 44 that is formed between the bearing housing 40 and the ball nut 10. The bearing housing 40 includes a port 46 formed therein and communicating with the annular gap 44 that is formed between the bearing housing 40 and the ball nut 10 for filling the lubricating oil into the annular gap 44 that is formed between the bearing housing 40 and the ball nut 10.

As shown in FIGS. 1, 3-4, the ball nut 10 further includes an outer peripheral groove 16 formed therein and located between the outer peripheral recesses 15 of the ball nut 10 and communicating with the annular gap 44 that is formed between the bearing housing 40 and the ball nut 10 for receiving or storing the lubricating oil, and includes an orifice 17 formed in the ball nut 10 (FIGS. 1-4) and communicating with the channel 14 of the ball nut 10 and the outer peripheral groove 16 of the ball nut 10 for receiving the lubricating oil and for allowing the lubricating oil to flow into the channel 14 of the ball nut 10 in order to lubricate the ball bearing members 33.

The lubricating device 4 further includes an oil scrubbing or actuating or propelling or forcing means or member 50 engaged into the orifice 17 of the ball nut 10 and secured to the ball nut 10 with such as fasteners or latches (not shown), adhesive materials, or by welding processes, the oil propelling or forcing means or member 50 includes a curved depression 51 formed therein and communicating with the channel 14 of the ball nut 10 (FIG. 3) for slidably receiving the ball bearing members 33 therein, and includes an extension 52 extended therefrom and extended into the outer peripheral groove 16 of the ball nut 10 and/or the annular gap 44 that is formed between the bearing housing 40 and the ball nut 10 for scrubbing or propelling or forcing the oil from the annular gap 44 and/or the outer peripheral groove 16 of the ball nut 10 into the curved depression 51 of the oil propelling or forcing means or member 50 and the channel 14 of the ball nut 10 in order to lubricate the ball bearing members 33.

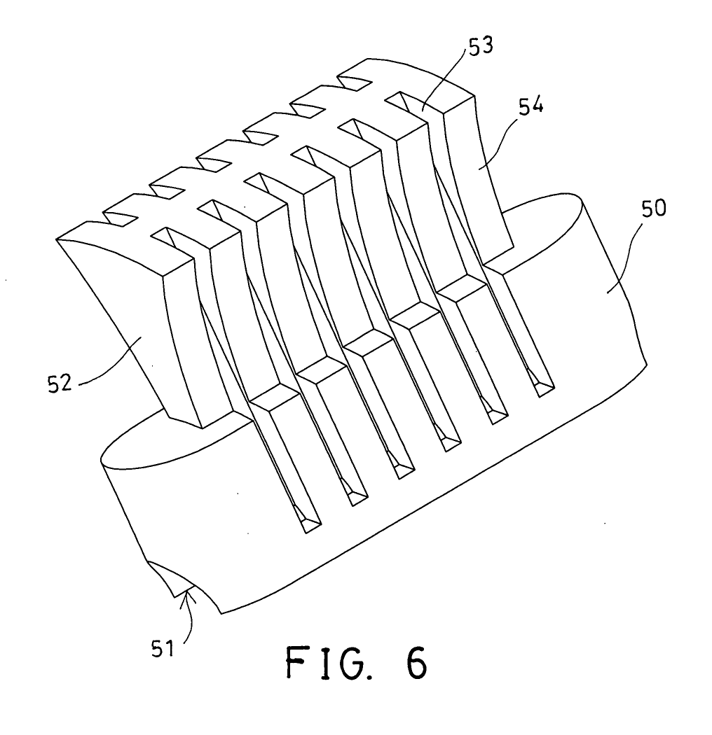

As shown in FIGS. 1-4 and 6, the oil forcing member 50 includes one or more pathways 53 formed therein, such as formed in either or both of the side portions 54 or the curved side portions 54 thereof and intersecting or communicating with the depression 51 of the oil forcing member 50 and/or the annular gap 44 that is formed between the bearing housing 40 and the ball nut 10 (FIGS. 4, 6) for allowing the oil to flow from the pathways 53 into the depression 51 of the oil forcing member 50, particularly when the ball nut 10 and the oil forcing member 50 are rotated or moved relative to the bearing housing 40. In operation, when the ball nut 10 and the oil forcing member 50 are rotated or moved relative to the bearing housing 40, the extension 52 that is extended into the outer peripheral groove 16 of the ball nut 10 and/or the annular gap 44 that is formed between the bearing housing 40 and the ball nut 10 may scrub or propel or force the oil to flow from the annular gap 44 and/or the outer peripheral groove 16 of the ball nut 10 into the curved depression 51 of the oil forcing member 50 and the channel 14 of the ball nut 10 in order to suitably lubricate the ball bearing members 33. The curved side portions 54 of the extension 52 may facilitate the scrubbing or propelling or forcing operation of the oil into the curved depression 51 of the oil forcing member 50 and the channel 14 of the ball nut 10.

It is to be noted that the engagement of the extension 52 of the oil forcing member 50 into the outer peripheral groove 16 of the ball nut 10 and/or the annular gap 44 that is formed between the bearing housing 40 and the ball nut 10 and the relative movement between the extension 52 of the oil forcing member 50 and the ball nut 10 and the bearing housing 40 may cause or force the extension 52 of the oil forcing member 50 to engage with the oil and to scrub or propel or force the oil to flow from the annular gap 44 and/or the outer peripheral groove 16 of the ball nut 10 into the curved depression 51 of the oil forcing member 50 and the channel 14 of the ball nut 10 in order to suitably lubricate the ball bearing members 33. The typical ball screw devices failed to provide an oil scrubbing or actuating or propelling or forcing means or member 50 for scrubbing or actuating or propelling or forcing the oil to flow from the annular gap 44 and/or the outer peripheral groove 16 of the ball nut 10 into the curved depression 51 of the oil forcing member 50 and the channel 14 of the ball nut 10.

Accordingly, the ball screw device in accordance with the present invention includes a lubricating device or structure for effectively and easily lubricating the balls or the bearing members, and for facilitating the rotational movement of the ball nut and the screw shaft relative to each other in great rotational speeds.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A ball screw device comprising:
a ball nut including a bore formed therein, and including an inner thread formed therein, and including a channel formed said ball nut and communicating with said inner thread of said ball nut, and including an orifice formed in said ball nut and communicating with said channel of said ball nut,
a screw shaft engaged into said bore of said ball nut and including an outer thread formed thereon for engaging with said inner thread of said ball nut and thus for allowing said ball nut to be rotated and moved relative to said screw shaft, and for forming a helical raceway between said ball nut and said screw shaft,
a plurality of first bearing members engaged in said helical raceway that is formed between said ball nut and said screw shaft and in said channel of said ball nut for facilitating a movement between said ball nut and said screw shaft,
a bearing housing rotatably engaged onto said ball nut for forming a sealed annular gap between said bearing housing and said ball nut, and for receiving a lubricating oil in said annular gap that is formed between said bearing housing and said ball nut and for lubricating said first bearing members, and
means for forcing the lubricating oil to flow from said annular gap that is formed between said bearing housing and said ball nut to said channel of said ball nut.

2. The ball screw device as claimed in claim 1, wherein said forcing means includes an oil forcing member engaged into said orifice of said ball nut and having an extension extended into said annular gap that is formed between said bearing housing and said ball nut for scrubbing and forcing the lubricating oil to flow from said annular gap that is formed between said bearing housing and said ball nut to said channel of said ball nut.

3. The ball screw device as claimed in claim 2, wherein said oil forcing member includes a curved depression formed therein and communicating with said channel of said ball nut for receiving said first bearing members.

4. The ball screw device as claimed in claim 3, wherein said bearing housing includes two sealing rings engaged between said bearing housing and said ball nut for forming said annular gap.

5. The ball screw device as claimed in claim 4, wherein said bearing housing includes two peripheral slots formed therein for receiving said sealing rings.

6. The ball screw device as claimed in claim 2, wherein said oil forcing member includes at least one pathway formed therein and communicating with said annular gap that is formed between said bearing housing and said ball nut.

7. The ball screw device as claimed in claim 6, wherein said at least one pathway is formed in either side portion of said oil forcing member.

8. The ball screw device as claimed in claim 7, wherein said side portion of said oil forcing member is a curved side portion.

9. The ball screw device as claimed in claim 1, wherein said ball nut includes an outer peripheral groove formed therein and communicating with said annular gap that is formed between said bearing housing and said ball nut for receiving the lubricating oil.

10. The ball screw device as claimed in claim 1, wherein said bearing housing includes a port formed therein and communicating with said annular gap that is formed between said bearing housing and said ball nut for filling the lubricating oil into said annular gap that is formed between said bearing housing and said ball nut.

11. The ball screw device as claimed in claim 1, wherein said ball nut includes at least one cavity formed therein and communicating with said bore of said ball nut for receiving a ball deflecting member therein.

12. The ball screw device as claimed in claim 11, wherein said ball deflecting member includes a curved slot formed therein for communicating said channel and said inner thread of said ball nut with each other.

13. The ball screw device as claimed in claim 1 further comprising a plurality of second bearing members engaged between said ball nut and said bearing housing.
